(19) United States
(12) Patent Application Publication
(10) Pub. No.: US 2011/0133553 A1
(43) Pub. Date: Jun. 9, 2011

(54) SYSTEM AND METHOD FOR DELAYING PHASE SHIFT WITHIN A DC/DC CONVERTER

(75) Inventors: TU A. BUI, RICHARDSON, TX (US); SICHENG CHEN, MCKINNEY, TX (US); JUN XIAO, DALLAS, TX (US)

(73) Assignee: INTERSIL AMERICAS INC., Milpitas, CA (US)

(21) Appl. No.: 12/898,963

(22) Filed: Oct. 6, 2010

Related U.S. Application Data
(60) Provisional application No. 61/249,371, filed on Oct. 7, 2009.

(51) Int. Cl. G05F 3/08

(52) U.S. Cl. 307/31

(57) ABSTRACT

A multi-output DC/DC voltage regulator has a master regulator for providing a first output voltage pulse responsive to an input voltage. The master regulator generates a synchronization signal that ramps from a first level up to a second level and discharges back to the first level responsive to the first output voltage pulse. At least one slave regulator provides a second output voltage pulse responsive the input voltage and a delay signal. The at least one slave regulator includes comparison logic for comparing the synchronization signal with a reference value and generates the delay signal to initiate the second output voltage pulse when the synchronization signal substantially equals the reference value. The first output voltage pulse is delayed from the second output voltage pulse by a selected amount.

### CROSS-REFERENCE TO RELATED APPLICATIONS

This application claims priority to U.S. Provisional Application No. 61/249,371, filed on Oct. 7, 2009, entitled SYSTEM AND METHOD FOR PROGRAMMING A TIME DELAY FOR PHASE SHIFTING IN A DC/DC CONVERTER which is incorporated herein by reference in its entirety.

### TECHNICAL FIELD

The present invention relates to DC/DC converters and more particularly to delaying phase shift within DC/DC converters.

### BACKGROUND

Multi-channel DC/DC converters are utilized in many applications wherein multiple output voltages are regulated from a single input voltage source. Within these applications, the power conversion of the switching regulators can impose high input RMS (Root Mean Square) current and noise issues. The frequency difference between one switching DC/DC regulator and another switching DC/DC regulator is called the “beat frequency.” If the beat frequency happens to be between 100 Hz and 23 kHz, an audio amplifier within the circuit may detect the beat frequency and disrupt system performance. In order to prevent this beat frequency, it is common to have all DC/DC converters in a multi-channel DC/DC converter synchronized to a specified frequency and delay the ON pulses within the converter. Synchronizing multi-channel DC/DC converters is a fairly easy and straightforward process, but the ability to program the phase shift can present many challenges to a circuit designer.

### SUMMARY

The present invention, as disclosed and described herein, in one aspect thereof, comprises a multi-output DC/DC voltage regulator that includes a master regulator for providing a first output voltage pulse responsive to an input voltage. The master regulator generates a synchronization signal that ramps from a first level up to a second level and discharges back down to the first level responsive to the first output voltage pulse. At least one slave regulator provides a second input voltage pulse responsive to the input voltage and a delay signal. The at least one slave regulator includes comparison logic for comparing a synchronization signal with a reference value and generating the delay signal to initiate the second output voltage when the synchronization signal substantially equals the reference value. The second output voltage pulse is delayed from the first output voltage pulse within the regulator.

### BRIEF DESCRIPTION OF THE DRAWINGS

For a more complete understanding, reference is now made to the following description taken in conjunction with the accompanying Drawings in which:

FIG. 1 is a schematic block diagram of a multi-channel DC/DC converter;

FIGS. 2a and 2b illustrate the differences between a multi-output DC/DC converter providing no phase shift and a multi-output DC/DC converter including a phase shift;

FIG. 3 illustrates a plot of ΔI_{IN}_{_{—}}IMS (n), Z versus the duty cycle for a single phase, two phase and three phase converter;

FIG. 4 illustrates a plot of the ΔI_{OUT}(n), D versus the duty cycle for a single phase, two phase and three phase converter;

FIG. 5 illustrates a functional block diagram for generating a time delay within the phase shifting between master regulator and slave regulator of a multi-channel DC/DC converter;

FIG. 6 is a block diagram illustrating a multi-channel DC/DC converter including the implementation of FIG. 5;

FIG. 7 illustrates the output waveforms associated with the DC/DC converter of FIGS. 5 and 6; and

FIG. 8 is a flow diagram describing the manner for delaying phase within a multi-channel DC/DC converter.

### DETAILED DESCRIPTION

Referring now to the drawings, wherein like reference numbers are used herein to designate like elements throughout, the various views and embodiments of a system and method for delaying phase shift within a DC/DC converter are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

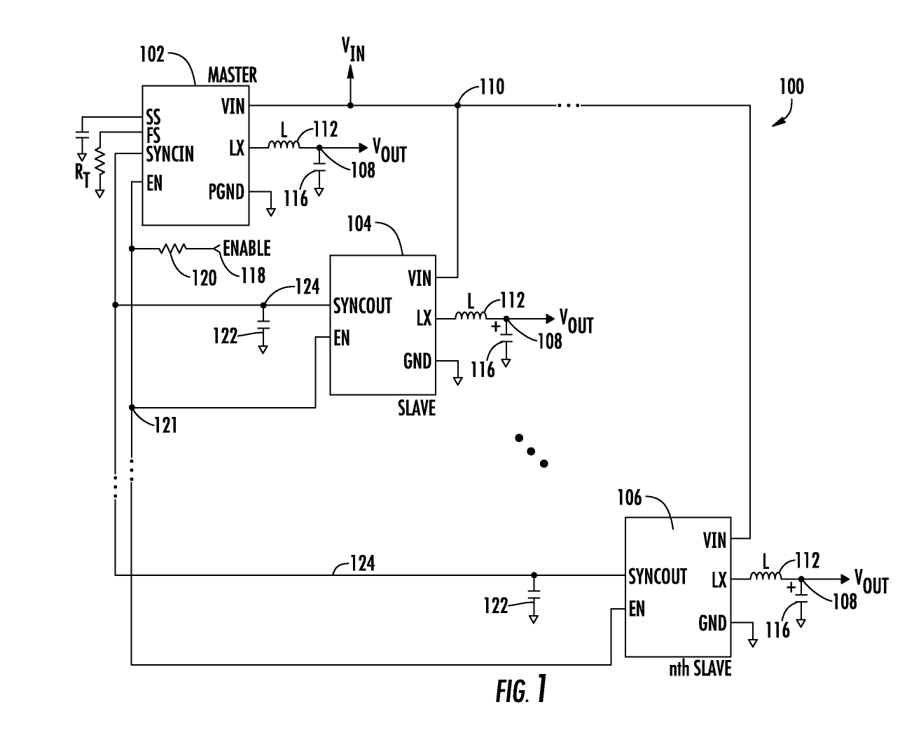

Referring now to the drawings, and more particularly to FIG. 1, there is illustrated a multi-channel DC/DC converter 100. The multi-channel DC/DC converter 100 includes a plurality of DC/DC regulators 102, 104 and 106. Each of the DC/DC regulators 102, 104 and 106 are responsible for generating an output voltage V_{OUT} at an output voltage node 108 responsive to an input voltage applied to the input pins V_{IN} of each of the DC/DC regulators 102. 104 and 106 at node 110. The input voltage V_{IN} is applied to the V_{IN} pin of each of the DC/DC regulators 102, 104 and 106. Connected to the LX voltage output pin of each DC/DC controller 100 is a filter consisting of an inductor 112 and a capacitor 116. The inductor 112 is connected between the LX output pin of the DC/DC regulators 102, 104 and 106 and the output voltage node V_{OUT} 108. The capacitor 116 is connected between the output voltage node 108 and ground. Each of the DC/DC regulators 102, 104 and 106 also include an enable input (EN) that is connected to receive an enable signal that is applied at node 118 through a resistor 120. One side of the resistor 120 is connected to node 118 and the other side is connected to node 121 that is connected to each of the EN pins of the DC/DC regulators 102, 104 and 106. The SYNCIN pin of the master regulator 102 is connected to the SYNCOUT pin inputs of each of the slave regulators 104 and 106 at node 124. A capacitor 122 is connected between node 124 and ground on the SYNCHOUT pins of the slaves 104 and 106. The master DC/DC regulator 102 establishes the set frequency for each of the slave regulators 104 and 106.

In most applications where multiple output voltages are regulated from a single input voltage source, the power conversion of the switching regulators can impose a high input RMS (root means square) current and noise issues. The frequency difference between one switching DC/DC regulator and another switching DC/DC regulator is called the “beat frequency.” If the beat frequency happens between 100 Hz and 23 kHz, an audio amplifier within the circuit may detect the beat frequency and disrupt system performance. In order to prevent this beat frequency, it is common to have all DC/DC converters in a multi-channel DC/DC converter synchronized to a specified frequency and delay the on pulses. Synchronizing multi-channel DC/DC converters is a fairly easy and straight forward process, but the ability to program the phase shift can present many challenges to a circuit designer.

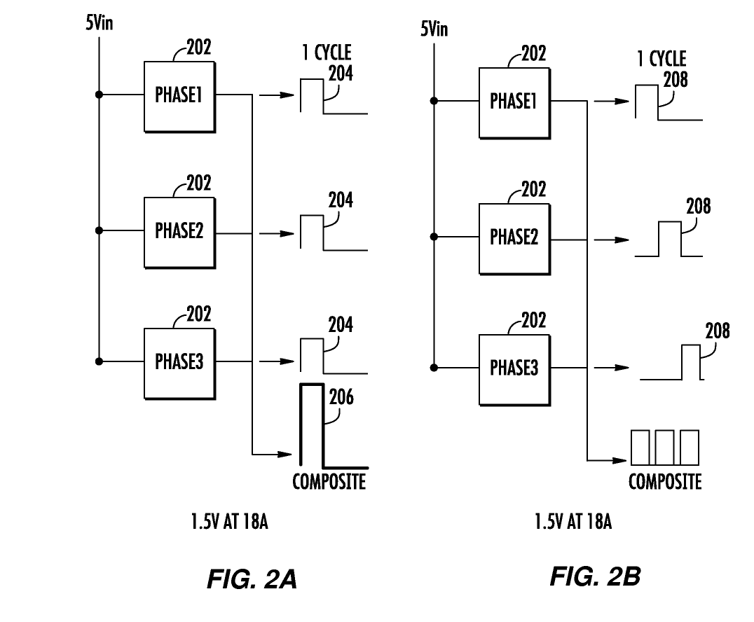

Referring now to FIGS. 2a and 2b, there are illustrated the operations of the multi-output DC/DC converter which includes no phase shift (FIG. 2a) and which includes a phase shift (FIG. 2b). In each of FIGS. 2a and 2b, there are illustrated three DC/DC converters 202 identified as phase 1, phase 2 and phase 3, respectively. The multi-phase converter of FIG. 2a consisting of converter 202 implements no phase shift within an output current pulse 204 generated responsive to an applied input voltage of 5 volts. Since there is no phase shift between the output current pulse 204 from each of the converters 202, a composite pulse 206 that is three times the magnitude of any of the individual pulses 204 is generated.

The multi-channel DC/DC converter including a phase shift as illustrated in FIG. 2b generates output current pulses 208 that are phase shifted from each other responsive to an input voltage of 5 volts. The composite signal 210 created by the pulses have a same magnitude as the individual pulses. The output current pulses in FIG. 2b are shifted 120 degrees per phase. The multi-output DC/DC converter including phase shift reduces both the input and output ripple current (if configured in an output current sharing mode). Of course, reducing the ripple current allows for less capacitance, less power dissipation and improves overall efficiency. Each design uses a three phase method to provide an 18 amp output current. Additional phases can be provided to provide higher current capabilities. Each converter 202 is the same for each application and is optimized to 6 amps. The non-phase shifted design provides a peak output current of 3×6 amps while the design implementing phase shifting provides a peak output current of only 6 amps.

The input and output capacitor requirements are significantly reduced using the phase shifted implementation. The Root Means Square (RMS) input current is determined according to the equation:

$$Δ Iin\_rms ( n , D ) = {[ \begin{matrix}[ ( D - \frac{k ( n , D )}{n} ) \cdot ( \frac{k ( n , D ) + 1}{n} - D ) ] + \\ {( \frac{n}{12 {D}^{2}} ) [ \frac{{V}_{OUT} \cdot ( 1 - D )}{L \cdot {F}_{s} \cdot {I}_{OUT}} ]}^{2} \cdot [ \begin{matrix}{( k ( n , D ) + 1 )}^{2} \cdot {( D - \frac{k ( n , D )}{n} )}^{3} + \\ {k ( n , D )}^{2} \cdot {( \frac{k ( n , D )}{n} - D )}^{3}\end{matrix} ]\end{matrix} ]}^{1 / 2}$$

where n is the number of phases, L is the output inductor value, S is the switching frequency and K(n,D) equals floor (n,D). The floor function returns the greatest integer less than or equal to the input value.

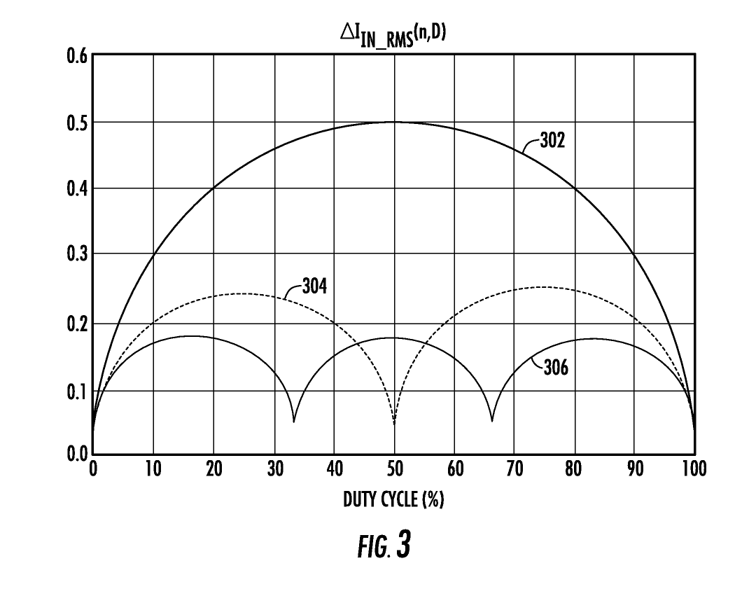

Referring now to FIG. 3, there is illustrated is a plot of ΔI_{IN}_{_{—}}RMS (n,D) versus the duty cycle. Line 302 represents the plot for a single phase regulator, line 304 represents the plot for two phase regulator and line 306 represents the plot for three phase regulator.

The estimated output ripple current is determined according to the equations:

$${I}_{RIPPLE} = \frac{{V}_{OUT} \cdot Δ {I}_{OUT} ( n , D )}{L \cdot {F}_{S}}$$

$$where Δ {I}_{OUT} ( n , D ) = \frac{{\prod }_{i = 1}^{n} \vert i - nD \vert}{{\prod }_{i = 1}^{n} ( \vert i - nD \vert + 1 )}$$

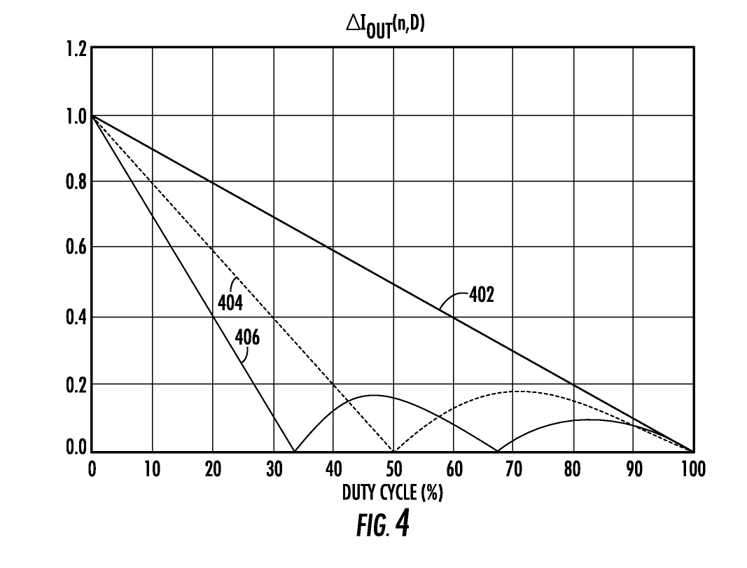

Referring now also to FIG. 4, there is illustrated a plot of the output current ΔI_{OUT} (n,D) versus the duty cycle. Line 402 represents a single phase regulator, line 404 represents a two phase regulator and line 406 represents a three phase regulator.

Referring now to Table 1 illustrated herein below, there is summarized a comparison of the performance between an in-phase converter and an out of phase converter. The parameter column sets out the parameters that are discussed within the table while the in-phase column represents the information for the parameters with respect to the in-phase multi-output DC/DC converter of FIG. 2a while the out of phase column is with respect to the multi-phase DC/DC converter of FIG. 2b. Each of the in-phase and out of phase converters includes three phases. The RMS input current for the in-phase converter is 8.1 amps while the RMS input current for the out of phase converter is only 2.2 amps. The input ripple voltage decreases when using the out of phase converter. The input ripple voltage is 180 millivolts with respect to the in-phase converter and only 60 millivolts with respect to the out of phase converter. The output ripple current is also greatly decreased using the out of phase converter with the output ripple current being 11.6 amps for the in-phase converter and only 1.8 amps for the out of phase converter. The output ripple voltage is also greatly decreased with the in-phase converter having an output ripple voltage of 58 millivolts while the out of phase converter has only 9 millivolts. The ripple frequency for the in-phase converter is 1 MHz while it is 3 MHz for the out of phase converter. These results demonstrate that the out of phase approach provides significant benefit over the in-phase converter design.

TABLE 1

| Parameter | In-Phase | Out-of-Phase |
|---|---|---|
| Number of Phase, n | 3 | 3 |
| Rms Input Current | 8.1 A | 2.2 |
| Input Voltage Ripple (10 mΩ R_{ESR} capacitor) | 180 mV | 60 mV |
| Output Ripple Current | 11.6 A | 1.8 |
| Output Ripple Voltage (5 mΩ R_{ESR} capacitor) | 58 mV | 9 mV |
| Ripple Frequency | 1 MHz | 3 MHz |

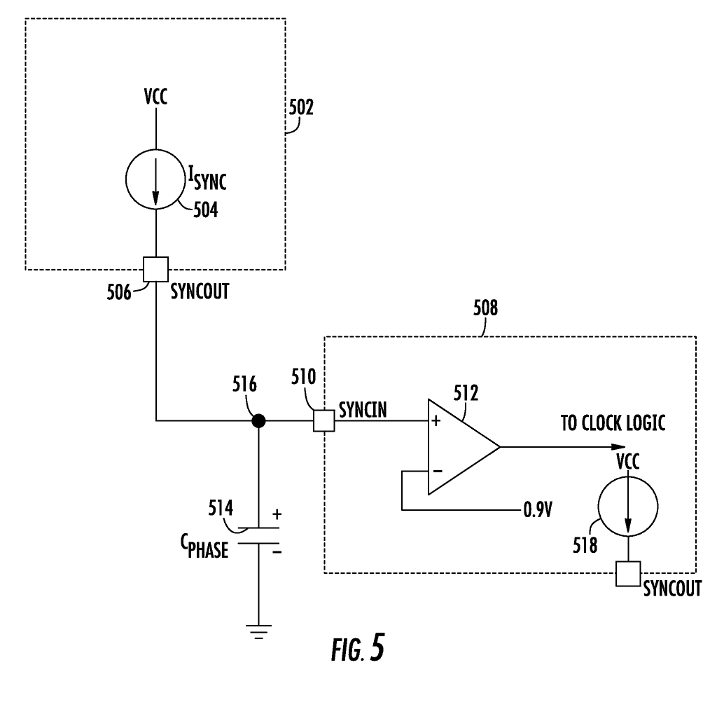

Referring now to FIG. 5, there is illustrated one implementation for a simple, low cost system to implement an out of phase operation within a multi-output DC/DC converter. In the implementation of FIG. 5, the master converter 502 includes a current source I_{SYNC} 504 that generates a source current to the SYNCOUT pin 506 of the master converter 502. The master converter 502 is connected to a slave converter 508 at its SYNCIN pin 510. The SYNCIN pin 510 connects to a non-inverting input of a comparator 512 within the slave converter 508. The non-inverting input of the comparator 512 is connected to a 0.9 volt reference voltage. While a 0.9 reference voltage is described, other voltage levels may be used. The comparator 512 compares the voltage at the SYNCIN pin 510 to the 0.9 volt reference voltage and generates a logical “high” signal when the voltage at the SYNCIN pin 510 equals or exceeds the 0.9 volt reference voltage. When the voltage at the SYNCIN pin 510 falls below the 0.9 volt reference voltage, the output of the comparator is at a logical “low” level. The output of the comparator 512 is provided to clock logic of the slave converter 508 that activates output voltage generation circuitry to generate the phase signal of the slave converter 508. The phase signal comprises the time the slave regulator is turned on to generate the output voltage signal. A capacitor 514 is connected between node 516 and ground. Node 516 is connected to the SYNCOUT pin 506 of the master controller 502 and the SYNCIN pin 510 of the slave converter 508.

The SYNCOUT pin 506 of the master converter 502 sources a current pulse (I_{SYNC}) which is initiated at the start of every master clock cycle of the master converter 502 responsive to the phase signal going high. The sourced current pulse is terminated and discharges to zero volts after the SYNCOUT voltage at pin 506 reaches 1 volt. The comparator 512 of the slave converter 508 provides a detection threshold of 0.9 volts. Each rising edge of the input provided at the SYNCIN pin 510 upon reaching the 0.9 volt level triggers a pulse of the phase signal from the output of the slave converter 508 responsive to the output of comparator 512. The capacitor 514 comprises a small low cost capacitor between node 516 and ground that enables the slew rate of the current source 504 to be changed. The phase shift time provided by the circuit is equal to 2.8 times the value of the capacitor 514 in picofarads. Thus, using the value of capacitor 514 the delay between phase pulses may be controlled.

Each slave converter 508 contains a current source 518 that provides the I_{SYNC} source current pulse to the SYNCOUT output pin that is provided to a next slave regulator within the multi-output DC/DC converter.

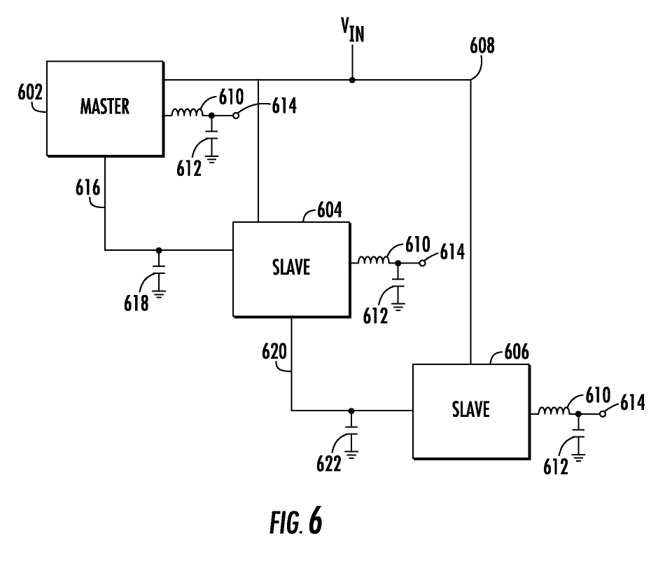

Referring now to FIG. 6, there is illustrated the manner in which a master regulator 602 would be interconnected with a pair of slave regulators 604 and 606. The input voltage V_{IN} is applied at node 608 to each of the master regulator 602, slave regulator 604 and slave regulator 606. Each of the regulators 602, 604 and 606 includes a filter consisting of an inductor 610 and a capacitor 612. The inductor 610 is connected between an output of the associated regulator 602, 604 and 606 and an output voltage pin 614. The capacitor 612 is connected between output voltage pin 614 and ground. The I_{SYNC} source current signal is provided from the master regulator 602 to the slave controller 604 over a line 616. A capacitor 618 is connected between line 616 and ground and is used for establishing the phase delay between master 602 phase pulse and slave 604 phase pulse. Line 620 provides the I_{SYNC} current source signal from slave 604 to slave 606. A capacitor 622 connected between line 620 and ground establishes the phase delay between the slave 604 phase pulse and slave 606 phase pulse.

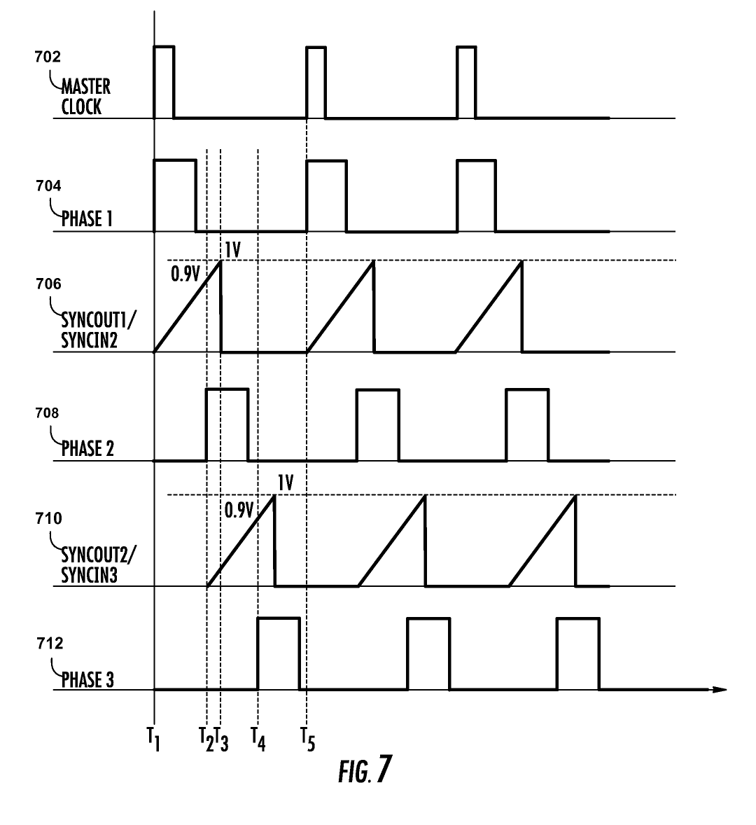

Referring now to FIG. 7, there are illustrated the various signals generated using the implementation described with respect to FIGS. 5 and 6. When the master clock signal 702 goes high at time T₁, this initiates a phase pulse 704 from the master controller at time T₁. The phase pulse represents the output voltage “on” time and is generated by output voltage circuitry of the master regulator responsive to a clock pulse. The phase pulse causes the SYNCOUT 1/SYNCIN 2 signal generated by the I_{SYNC} current source to begin increasing from time T₁ to time T₂. The SYNCOUT 1/SYNCIN 2 signal is provided at the SYNCOUT pin of the master regulator and the SYNCIN pin of the slave regulator. The SYNCOUT 1/SYNCIN 2 signal 706 continues increasing from time T₁ to time T₂ until the signal reaches 0.9 volts. This is detected by the comparator 512 within the slave converter 508 causing the phase two pulse 708 to be generated by the output voltage circuitry within the slave controller at time T₂. The phase two signal 708 rising edge initiates the generation of the SYNCOUT 2/SYNCIN 3 signal at time T₃ by the I_{SYNC} current source 518 within the slave converter 508. This causes the SYNCOUT 2/SYNCIN 3 signal 710 to begin increasing from time T₂ to T₄.

The SYNCOUT 1/SYNCIN 2 signal 706 continues increasing until it reaches one volt at time T₃. At this point, the current source 504 is discharged to ground and the SYNCOUT 1/SYNCIN 2 signal drops to zero. The SYNCOUT 2/SYNCIN 3 signal continues to increase until time T₄ when it reaches 0.9 volts. This causes the comparator within the next slave converter 508 to generate the phase three pulse signal 712 at time T₄. The SYNCOUT 2/SYNCIN 3 signal continues to increase until it reaches one volt at which time the current source 518 is discharged to zero. The phase three pulse 712 could cause the generation of a subsequent SYNCOUT/SYNCIN signal if additional slaves were included within the multi-output converter. However, if no further slave converters 508 were included, no additional SYNCOUT pulse will be necessary. The process begins repeating at time T₅ upon the next master clock pulse 702 at the master regulator.

The described circuit may be implemented in a simple fashion and requires only a 70 mil square die area. The design is trimmable to achieve +/−5% tolerance. The threshold of the SYNCIN is trimmable to +/−0.5%. Finally, the capacitance required to set the phase delay is in the order of nanofarads which is low cost, and can easily come in NPO or COG electric class ceramic capacitors having a tolerance of +/−1%. Thus, the phase shift tolerance is approximately 5.12%. Thus, the implementation enables the programming of the time delay for phase shifting multi-rail or multi-phase DC/DC converters enabling them to operate in an out of phase condition and reduce input capacitance requirements and electromagnetic interference.

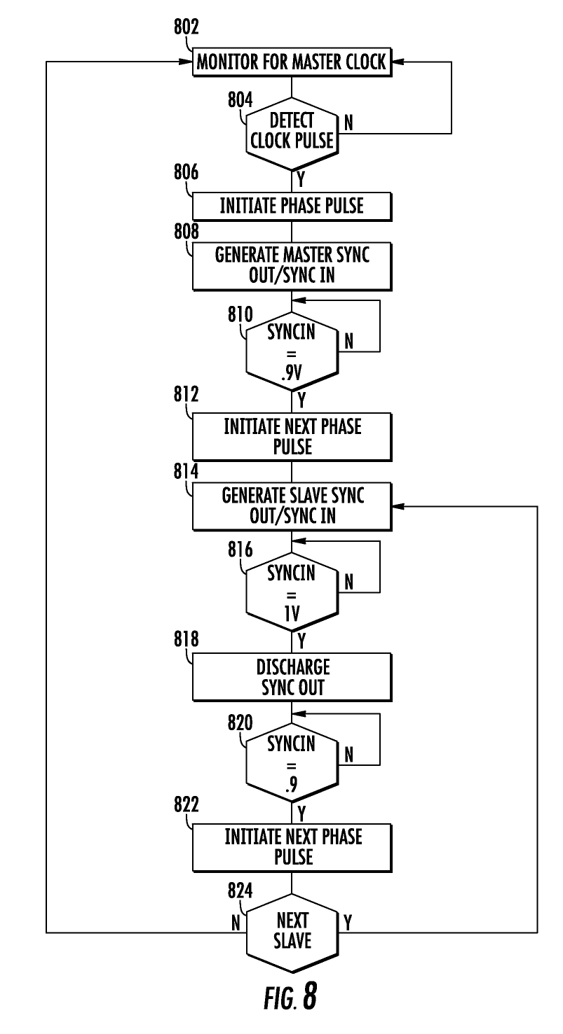

Referring now to FIG. 8, there is illustrated a flow diagram describing operation of the circuit having a programmed phase delay. As the circuit is operating, the master clock signal is monitored at step 802. Inquiry step 804 determines when a clock pulse occurs and once a clock pulse is detected, an output voltage phase pulse within the master is generated at step 806. Responsive to the phase pulse, the master SYNCOUT/SYNCIN signal from the current source is initiated at step 808. Inquiry step 810 monitors the master SYNCOUT/SYNCIN signal to determine when it reaches 0.9 volts. Upon determination that the master SYNCOUT/SYNCIN signal has reached 0.9 volts, an output voltage phase pulse from the slave is initiated at step 812. The slave output voltage phase pulse initiates a slave SYNCOUT/SYNCIN signal generation at step 814.

Inquiry step 816 continues monitoring the master SYNCOUT/SYNCIN signal to determine when the signal reaches one volt. Once the master SYNCOUT/SYNCIN signal equals one volt the current source within the master is discharged at step 818 to zero to discharge the SYNCOUT signal. Inquiry step 820 monitors the slave SYNCOUT/SYNCIN signal to determine when the signal equals 0.9 volts. Upon reaching 0.9 volts, the next output voltage phase signal pulse is initiated at step 822. Inquiry step 824 determines whether an additional slave exists within the multi-output DC/DC converter. If not, control passes back to step 802 where a next master clock signal pulse is monitored for to initiate a next cycle. If additional slaves exist, the next slave SYNCOUT/SYNCIN signal is initiated back at step 814. The process continues to repeat responsive to successive master clock pulses.

It will be appreciated by those skilled in the art having the benefit of this disclosure that this system and method for delaying phase shift within a dc/dc converter provides a method for controlling pulse delay between pulses. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A multi-output DC/DC voltage regulator, comprising:
a master regulator for providing a first output voltage pulse responsive to an input voltage, the master regulator generating a synchronization signal that ramps from a first level up to a second level and discharges back to the first level responsive to the first output voltage pulse;
at least one slave regulator for providing a second output voltage pulse responsive to the input voltage and a delay signal, the at least one slave regulator including comparison logic for comparing the synchronization signal with a reference value and generating the delay signal to initiate the second output voltage pulse when the synchronization signal substantially equals the reference value; and
wherein the second output voltage pulse is delayed from the first output voltage pulse.

2. The multi-output DC/DC voltage regulator of claim 1, further including a capacitor for programming an amount of delay between the first output voltage pulse and the second output voltage pulse.

3. The multi-output DC/DC voltage regulator of claim 1, wherein the master regulator further includes a current source for generating the synchronization signal at an output pin of the master regulator.

4. The multi-output DC/DC voltage regulator of claim 1, wherein the comparison logic further comprises a comparator for comparing the synchronization signal with the reference value, the comparator generating the delay signal at a first logical level to initiate the second output voltage pulse when the synchronization signal substantially equals the reference value.

5. The multi-output DC/DC voltage regulator of claim 1, further including a plurality of filters connected to receive the first and second output voltage pulses from each of the master regulator and the at least one slave regulator, the filter further comprising:
an inductor; and
a capacitor connected to the inductor.

6. The multi-output DC/DC voltage regulator of claim 1, wherein the at least one slave regulator further generates a second synchronization signal that ramps from the first level up to the second level and discharges back to the first level responsive to the second output voltage pulse, the second synchronization signal being applied to another of the at least one slave regulators.

7. The multi-output DC/DC voltage regulator of claim 6, wherein the at least one regulator further includes a second current source for generating the second synchronization signal at an output pin of the at least one slave regulator.

8. A voltage regulator for use with a multi-output DC/DC voltage regulator, comprising:
voltage regulation circuitry for generating an output voltage pulse responsive to an input voltage and a delay signal;
synchronization circuitry for generating an output synchronization signal that ramps from a first level up to a second level and discharges back to the first level responsive to the output voltage pulse; and
comparison logic for comparing a received synchronization signal with a reference value and generating the delay signal to initiate the output voltage pulse when the received synchronization signal substantially equals the reference value.

9. The voltage regulator of claim 8, further including a capacitor connected external to the regulator for programming an amount of delay between the output voltage pulse and a second output voltage pulse of a regulator receiving the output synchronization signal.

10. The voltage regulator of claim 8, wherein the synchronization circuitry further includes a current source for generating the output synchronization signal at an output pin of the regulator.

11. The voltage regulator of claim 8, wherein the comparison logic further comprises a comparator for comparing the received synchronization signal with the reference value, the comparator generating the delay signal at a first logical level to initiate the output voltage pulse when the received synchronization signal substantially equals the reference value.

12. The voltage regulator of claim 8, further including a filter connected to receive the output voltage pulse from the regulator, the filter further comprising:
an inductor; and
a capacitor connected to the inductor.

13. A method for delaying phases within a multi-output DC/DC voltage regulator, comprising the steps of:
generating a first output voltage pulse at a master regulator responsive to an input voltage;
generating a synchronization signal at the master regulator that ramps from a first level up to a second level and discharges back to the first level responsive to the first output voltage pulse;
comparing the synchronization signal with a reference value at a slave regulator;
generating a delay signal to initiate a second output voltage pulse when the synchronization signal substantially equals the reference value at the slave regulator; and
generating the second output voltage pulse that is delayed from the second output voltage pulse responsive the input voltage and the delay signal at the slave regulator.

14. The method of claim 13, further including the step of programming an amount of the delay between the first output voltage pulse and the second output voltage pulse using a capacitor.

15. The method of claim 13, wherein the step of generating the synchronization signal further comprise the step of providing a source current at an output pin of the master regulator.

16. The method of claim 13, wherein the step of generating the delay signal further comprises the steps of:
generating the delay signal at a first logical level to initiate the second output voltage pulse when the synchronization signal substantially equals the reference value; and
generating the delay signal at a second logical level when the synchronization signal is below the reference value.

17. The method of claim 13, further including the step of filtering the first and second output voltage pulses from each of the master regulator and the at least one slave regulator.

18. The method of claim 13, further including the steps of:
generating a second synchronization signal at the slave regulator that ramps from the first level up to the second level and discharges back to the first level responsive to the second output voltage pulse; and
applying the second synchronization to a second slave regulator.

19. The method of claim 13, wherein the step of generating the second synchronization signal further comprise the step of providing a second source current at an output pin of the slave regulator.

20. The method of claim 13, wherein the step of generating the synchronization signal further comprises the steps of:
ramping the synchronization signal from the first level up to the second level; and
discharging the synchronization signal back to the first level responsive to the synchronization signal reaching the second level.
